(19) United States
(12) Patent Application Publication
(10) Pub. No.: US 2024/0337121 A1
(43) Pub. Date: Oct. 10, 2024

(54) COVERING PANEL FOR COVERING WORK AREAS

(71) Applicant: Ibel Agustin Balbia Farinha, Montivideo (UY)

(72) Inventor: Ibel Agustin Balbis Farinha, Montevideo (UY)

(21) Appl. No.: 18/625,836

(22) Filed: Apr. 3, 2024

(30) Foreign Application Priority Data
Apr. 4, 2023 (ES) ES202330574U

(51) Int. Cl. E04G 21/30; F16B 5/06

(52) U.S. Cl. CPC E04G 21/30; F16B 2005/0678

(57) ABSTRACT

The present invention relates to a covering panel that serves to cover work areas that comprises two external sheets (1) of corrugated plastic that are joined together by transverse sections (2) to the external sheets, both made of polypropylene, where each of the sheets is provided with eyelets (3) or perforations arranged near the 4 corners or along the sides. The panel enables protecting loading and unloading platforms, as well as industrial floors or indoor and outdoor construction, including non-horizontal surfaces such as walls, dividers, columns and/or fragile parts to be preserved undamaged, such as works of art, glass, decorations and equipment and installations.

### OBJECT OF THE INVENTION

The object of the present invention, as established by the title of the invention, is a covering panel for covering work areas that is easy to install and adjust in a way that provides protection to workers and to the surroundings due to the fact that it is a water-resistant and fire-retardant surface.

The present invention is characterised by the manufacturing material of the panels and the fact that it has means that enable panels to be joined in a simple and efficient way.

Therefore, the present invention falls within the scope of materials used to cover loading, unloading and work area surfaces during indoor and outdoor construction in the naval industry or on land.

### BACKGROUND OF THE INVENTION

In the state of the art, when there is a desire to protect work area surfaces or floors, multi-layer protective sheets for floors and surfaces, especially for construction sites, which offer anti-impact, waterproof and self-adhesive properties, are used.

Solutions based on temporary protection rolls are also known, which are made of compact white cardboard with a plastic sheet adhered on one side, which provide waterproofing and high resistance to breakage, tearing and small impacts.

It offers good protection for floors and is extremely resistant to breakage, tears, liquids and other dirt from the construction site.

The high resistance to breakage allows the passage of scaffolding with wheels and occasionally machinery at a maximum of 3 km/h, perfectly withstanding the constant traffic of the different parties at the construction site.

Its white colour provides great brightness to construction sites and offers greater visual safety to the parties.

It is one of the best alternatives for providing all types of pavement protection and it is more resistant than corrugated cardboard rolls.

Although these sheets fulfil the intended purpose, on the one hand, they are quite expensive, and on the other, they are complex to assemble, in addition to not being fire-retardant.

Therefore, an object of the present invention is to overcome the drawbacks of the state of the art by developing a protective system for floors or surfaces that, in addition to offering protection, offers non-slip, water-resistant and fire-retardant properties, developing a covering panel such as the one described below and included in its essentiality in the first claim.

### DESCRIPTION OF THE INVENTION

The object of the present invention is included in its essentiality in the independent claim and the different embodiments are included in the dependent claims.

The object of the present invention is a covering panel for covering work areas, which is easy to install and provides protection to workers and to the surroundings due to the fact that it is non-slip, water-resistant and fire-retardant, having a fastening system provided by the prefabricated holes in the same panel.

It is made up of two external sheets parallel to each other and joined by sheets perpendicular to these external sheets, made of corrugated polypropylene having a composition containing a fire-retardant in different degrees according to the needs of the project.

Corrugated plastic is a thermoplastic with a crystalline structure that is obtained by polymerisation of propylene. Its qualities enable it to be printed, die-cut, cut and assembled in many different ways. Due to its resistance, durability and low weight, this sheet constitutes a superior alternative to other materials such as cardboard, hardboard, metal, wood and injected plastics.

### Its Properties are:

High melting point plastic
Resistant to impact and high temperatures
Shades in natural, white and colour
Low moisture absorption coefficient
Aroma barrier
Unbreakable
Chemical resistance
Ability to be thermoformed
Chemical resistance to acids, oils, etc.
Waterproof, flexible and lightweight
Non-toxic
Recyclable

Each of the covering panels object of the invention has perforations arranged near each of its corners so that when several panels are coupled in an adjacent manner, they can be joined by a flange or similar, in order to protect the surface of choice, leaving said perforations at a distance of up to about 30 cm from the edges.

Its logistical versatility includes ease of transportation and handling during the assembly of the protective layer, in addition to the safety obtained by the fixing system achieved by the designed eyelets and fasteners that fix the units in a practical and safe way, allowing agile assembly and disassembly and relocation in the event of moving or reusing the panels.

The panel enables protecting loading and unloading platforms, as well as industrial floors or indoor and outdoor construction, including non-horizontal surfaces such as walls, dividers, columns and/or fragile parts to be preserved undamaged, such as works of art, glass, decorations and equipment and installations.

Except when indicated otherwise, all of the technical and scientific elements used in this specification have the meaning commonly understood by a person with average skill in the art to which this invention belongs. When this invention is put into practice, methods, materials and dimensions may be used that are similar or equivalent to the ones described in the specification.

Throughout the description and the claims, the word “comprise” and its variants are not intended to exclude other technical features, additions, components or steps. For those skilled in the art, other objects, advantages and features of the invention will be deduced from both the description and the practical use of the invention.

### DESCRIPTION OF THE FIGURES

As a complement to the description provided herein, and for the purpose of helping to make the features of the invention more readily understandable, in accordance with a preferred practical exemplary embodiment thereof, said description is accompanied by a set of drawings which, by way of illustration and not limitation, represent the following.

FIG. 1 shows a partial representation of a panel object of the invention.

FIG. 2 shows a detail of one of the eyelets or perforations placed near the corners.

FIG. 3 shows a panel in plan view.

FIG. 4 shows a possible manner of joining two adjacent panels.

### PREFERRED EMBODIMENT OF THE INVENTION

In light of the figures, a preferred embodiment of the proposed invention is described below.

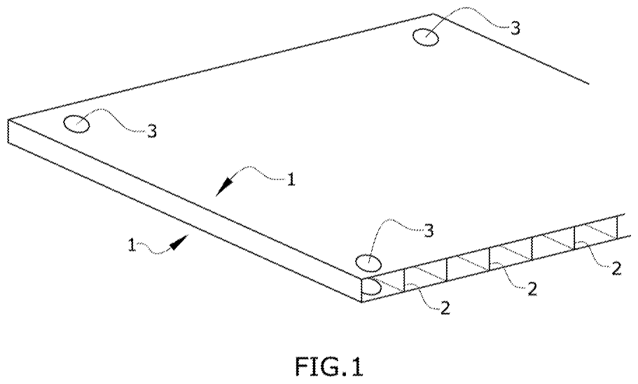

FIG. 1 shows that the panel object of the invention comprises two external sheets (1) of corrugated plastic that are joined together by transverse sections (2) to the external sheets, both made of polypropylene.

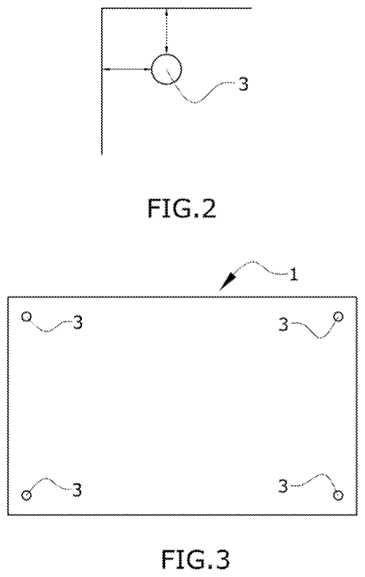

Each of the sheets is provided with eyelets (3) or perforations arranged near the corners, which, in a possible non-limiting embodiment, can have a diameter of about 2 cm (+1 cm) and be at a distance≤30 cm from each side, as shown in FIG. 2 by way of example.

FIG. 3 shows a covering panel provided with four eyelets (3) arranged near the corners.

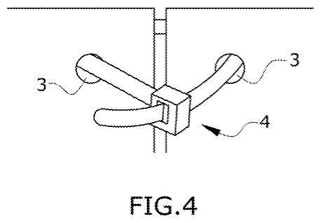

FIG. 4 shows that the panels are joined together by flanges (4) that, passing through the eyelets (3), join their ends together. The manner of joining by means of flanges is one of the possible manners of joining that does not limit the invention, nor is the type of means used in the joining between panels an object thereof.

Having thus adequately described the nature of the present invention, as well as how to put it into practice, it must be noted that, within its essential nature, the invention may be carried out according to other embodiments differing in detail from that set out by way of example, which the protection sought would equally cover, provided that the fundamental principle thereof is not altered, changed or modified.

1. A covering panel for covering work areas that comprises two external sheets (1) of corrugated plastic that are joined together by transverse sections (2) to the external sheets, both made of polypropylene, characterised in that each of the sheets is provided with eyelets (3) or perforations arranged near the 4 corners or along the sides.

2. The covering panel for covering work areas according to claim 1, characterised in that the eyelets (3) have a diameter of about 2 cm+1 cm and are located at a distance≤30 cm from each side or edge.
